(19) United States
(12) Patent Application Publication
(10) Pub. No.: US 2024/0363265 A1
(43) Pub. Date: Oct. 31, 2024

(54) WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Toshiya HIROOKA, Yokkaichi-shi (JP); Hiroki TAMARU, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/289,309

(22) PCT Filed: Mar. 29, 2022
(86) PCT No.: PCT/JP2022/015330

§ 371 Date: Nov. 2, 2023

(30) Foreign Application Priority Data
May 20, 2021 (JP) 2021-085271

(51) Int. Cl. H01B 7/282; H01B 3/44; H01B 7/00; H01B 7/02

(52) U.S. Cl. CPC H01B 7/2825; H01B 3/441; H01B 7/0045; H01B 7/0216; H01B 7/0266

(57) ABSTRACT

A wire harness including: a shielded wire having a core wire, an insulating coating covering an outer periphery of the core wire, and a braid covering an outer periphery of the insulating coating; a housing covering an outer periphery of the braid; and a water-stop cover that fills a mesh of the braid and is located between the housing and the insulating coating, wherein the water-stop cover has an elastic tube and is held between the housing and the insulating coating.

### BACKGROUND

The present disclosure relates to a wire harness.

Some type of conventional wire harness includes a shield wire having an electric wire and a braided member covering the outer periphery of the electric wire, a grommet that covers the outer periphery of the braided member, and a water-stop portion that fills mesh of the braided member and is located between the electric wire and the grommet (e.g. see JP 2017-220972A). The water-stop portion is made of resin and molded so as to fit into the mesh of braided member. With the wire harness having this configuration, the water-stop portion prevents liquids, such as water, from moving along the electric wire without disrupting the electromagnetic shielding effect obtained by the braided member, which is made of metal.

### SUMMARY

In the above wire harness, the outer periphery of the water-stop portion is pressed by the grommet, but is pressed only with the elasticity of the grommet. If, for example, the grommet deteriorates, the water-stop portion may not be able to maintain its water-stop performance. That is, there is a concern that deterioration of the grommet may allow liquids to pass between the water-stop portion and the grommet and between the water-stop portion and the electric wire.

An exemplary aspect of the disclosure provides a wire harness that is able to have improved water-stop performance and durability.

A wire harness of the present disclosure is a wire harness comprising: a shielded wire having a core wire, an insulating coating covering an outer periphery of the core wire, and a braid covering an outer periphery of the insulating coating; a housing covering an outer periphery of the braid; and a water-stop cover that fills a mesh of the braid and is located between the housing and the insulating coating, wherein the water-stop cover has an elastic tube and is held between the housing and the insulating coating.

According to the wire harness of the present disclosure, water-stop performance and durability can be improved.

### BRIEF DESCRIPTION OF THE DRAWINGS

FIG. 1 is a partial cross-sectional view of a wire harness according to an embodiment.

FIG. 2 is a cross-sectional view illustrating a process of producing the wire harness according to the embodiment in FIG. 1.

FIG. 3 is a partial cross-sectional view of a wire harness in another example.

### DETAILED DESCRIPTION OF EMBODIMENTS

### Description of Embodiments of Present Disclosure

Firstly, modes for implementing the present disclosure will be listed and described.

A wire harness of the present disclosure is

[1] a wire harness comprising: a shielded wire having a core wire, an insulating coating covering an outer periphery of the core wire, and a braided member covering an outer periphery of the insulating coating; a housing covering an outer periphery of the braided member; and a water-stop member filling mesh of the braided member and located between the housing and the insulating coating, wherein the water-stop member has an elastic portion and is held between the housing and the insulating coating.

According to this configuration, the water-stop member, which has its own elastic portion, is able to have increased water-stop performance and durability compared to, for example, a configuration in which the water-stop member is pressed against the insulating coating by only the elasticity of the grommet.

[2] It is preferable that the water-stop member has a resin portion and the elastic portion, the resin portion fills the mesh of the braided member and is located in an area reaching the insulating coating, and the elastic portion is held between the housing and the resin portion.

According to this configuration, the elastic portion pressing the resin portion against the insulating coating can increase water-stop performance and durability.

[3] It is preferable that the elastic portion has a hardness lower than a hardness of the resin portion.

According to this configuration, the resin portion is pressed against the insulating coating while the elastic portion is flatly pressed.

[4] It is preferable that the resin portion is adhered to the insulating coating.

According to this configuration, the adhesion eliminating a gap between the resin portion and the insulating coating can increase water-stop performance and durability.

[5] It is preferable that the insulating coating and the resin portion are both made of polyolefin resin.

According to this configuration, excellent adhesion between the insulating coating and the resin portion can be achieved.

[6] It is preferable that the entire water-stop member is the elastic portion.

According to this configuration, the elasticity of the water-stop member brings the housing and the water-stop member into intimate contact with each other and also brings the water-stop member and the insulating coating into intimate contact with each other, thus making it possible to increase water-stop performance and durability.

[7] It is preferable that an inner side of the water-stop member in a radial direction is adhered to the insulating coating, and an outer side of the water-stop member in the radial direction is flatly pressed and in intimate contact with the housing.

According to this configuration, the water-stop member fills a gap with the insulating coating by being adhered on the inner side in the radial direction, and fills a gap with the housing by being flatly pressed on the outer side in the radial direction. Accordingly, water-stop performance and durability can be increased on the inner and outer sides in the radial direction.

### Details of Embodiments of Present Disclosure

Specific examples of the wire harness of the present disclosure will be described below with reference to the drawings. The drawings may exaggerate or simplify some constituents for convenience of description. The dimensional ratio of each part may differ between the drawings. The term “parallel” in the present specification includes not only the case of being strictly parallel but also the case of being substantially parallel within a range that exhibits the operation and effects of the present embodiment. The term “orthogonal” in the present specification includes not only the case of being strictly orthogonal but also the case of being substantially orthogonal within a range that exhibits the operation and effects of the present embodiment. Note that the present disclosure is not limited to these examples but is described by the claims, and is intended to include all changes made within the meaning and scope equivalent to the claims.

### Configuration of Wire Harness 10

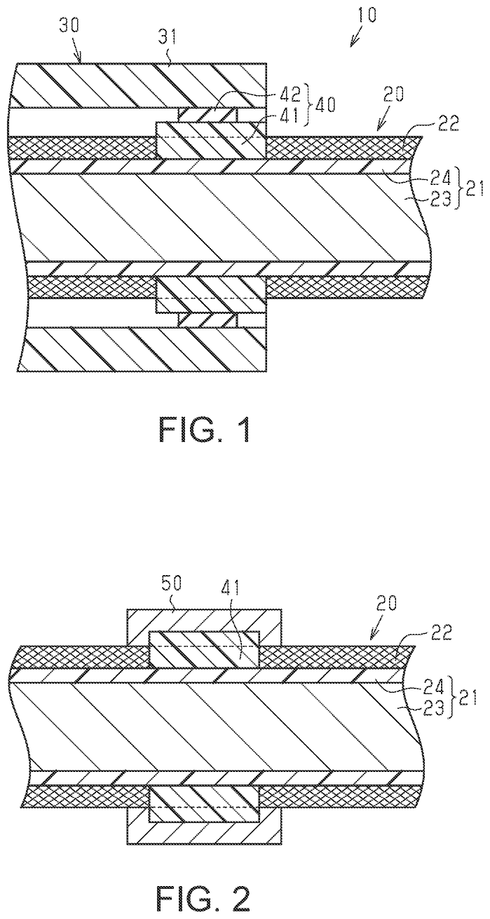

As shown in FIG. 1, a wire harness 10 includes a shielded wire 20, a connector 30, and a water-stop member 40 (water-stop cover).

### Shielded Wire 20

The shielded wire 20 has an electric wire 21 and a braided member 22 (braid). The electric wire 21 has a core wire 23 that is made of a conductor, and an insulating coating 24 that covers the outer periphery of the core wire 23. The insulating coating 24 of the present embodiment is made of polyolefin resin. The braided member 22 covers the outer periphery of the insulating coating 24. The braided member 22 is constituted by a plurality of woven metal wires. The material of the metal wires may be a copper- or aluminum-based metal material, for example.

### Configuration of Connector 30

The connector 30 has a housing 31. The housing 31 has a tubular shape. The housing 31 covers the outer periphery of the braided member 22. The connector 30 has a terminal (not shown) or the like that is electrically connected to the core wire 23.

### Water-Stop Member 40

The water-stop member 40 fills the mesh of the braided member 22 and is held between an inner face of the housing 31 and an outer face of the insulating coating 24. The water-stop member 40 is located at an opening end portion of the housing 31.

Specifically, the water-stop member 40 has a resin portion 41 (resin filler) and an elastic portion 42 (elastic tube). The resin portion 41 fills the mesh of the braided member 22 and is located in an area reaching the insulating coating 24. An outer peripheral face of the resin portion 41 is located on the outer side of an outer peripheral face of the braided member 22. The outer peripheral face of the resin portion 41 is a flat face without unevenness. The resin portion 41 is adhered to the insulating coating 24. The resin portion 41 is made of polyolefin resin.

As shown in FIG. 2, the resin portion 41 is molded by filling an area enclosed by a mold 50, which is positioned at the outer periphery of the braided member 22, with a resin material in a molten state. At this time, the resin material in a molten state enters the mesh of the braided member 22 from the outer side in the radial direction, or more specifically, gaps between the metal wires that constitute the braided member 22, and is cured and adhered to the insulating coating 24 after reaching the insulating coating 24.

As shown in FIG. 1, the elastic portion 42 has a tubular shape. The elastic portion 42 is made of rubber. The elastic portion 42 has a hardness higher than that of the resin portion 41. The elastic portion 42 is held between the housing 31 and the resin portion 41. In other words, the elastic portion 42 is held while being compressed between the housing 31 and the resin portion 41.

Next, the operation of the wire harness 10 having the above configuration will be described.

The water-stop member 40, which fills the mesh of the braided member 22, prevents liquids such as water from entering the interior of the connector 30 along the electric wire 21 from outside the connector 30 without interrupting the electromagnetic shielding effect of the braided member 22, for example.

Next, the effects of the above embodiment will be described below.

(1) The water-stop member 40, which has its own elastic portion 42 and is held between the housing 31 and the insulating coating 24, is able to have increased water-stop performance and durability compared to, for example, a conventional configuration in which a water-stop member is pressed against an insulating coating by only the elasticity of a grommet. Further, compared to the case where, for example, water-stop performance is ensured by covering the entire outer periphery of the braided member 22 with a sheath or the like, the sheath or the like is unnecessary, and the flexibility of the wire harness 10 can be ensured since the sheath or the like does not inhibit the flexibility.

(2) The water-stop member 40 has the resin portion 41 and the elastic portion 42. The elastic portion 42 of the water-stop member 40 is held between the housing 31 and the resin portion 41 and thus presses the resin portion 41 against the insulating coating 24. This can increase water-stop performance and durability of the water-stop member 40. The elastic portion 42 has a hardness lower than that of the resin portion 41, thereby causing the resin portion 41 to be pressed against the insulating coating 24 while the elastic portion 42 is flatly pressed.

(3) The resin portion 41 is adhered to the insulating coating 24, and the adhesion eliminates a gap between the resin portion 41 and the insulating coating 24, thus increasing water-stop performance and durability.

(4) Since the insulating coating 24 and the resin portion 41 are both made of polyolefin resin, excellent adhesion between the insulating coating 24 and the resin portion 41 is achieved.

The present embodiment can be modified as follows for implementation. The present embodiment and the following modifications can be implemented in combination as long as no technical contradiction arises.
The water-stop member 40 of the above embodiment has the resin portion 41 and the elastic portion 42, but this configuration can be changed to another as long as the water-stop member 40 fills the mesh of the braided member 22, has an elastic portion, and is held between the housing 31 and the insulating coating 24.

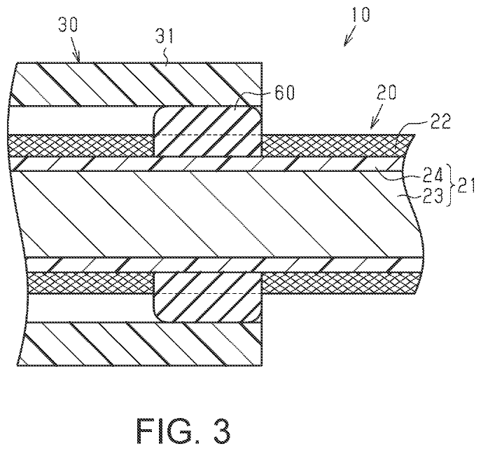

For example, an entire water-stop member 60 may be an elastic portion, as shown in FIG. 3. That is, the water-stop member 60 in this example is entirely made of rubber, for example. The water-stop member 60 fills the mesh of the braided member 22 and is held between the housing 31 and the insulating coating 24. Note that the water-stop member 60 in this example may be but need not be adhered to the insulating coating 24. Specifically, the water-stop member 60 may have a configuration in which the inner side thereof in the radial direction is adhered to the insulating coating 24 and the outer side in the radial direction is flatly pressed and in intimate contact with the housing 31.

With this configuration as well, the elasticity of the water-stop member 60 brings the housing 31 and the water-stop member 60 into intimate contact with each other and also brings the water-stop member 60 and the insulating coating 24 into intimate contact with each other, thus making it possible to increase water-stop performance and durability. Further, the number of molded components can be reduced and the water-stop member 60 can be easily obtained compared to the water-stop member 40 that had the resin portion 41 and the elastic portion 42 as in the above embodiment. Further, if the water-stop member 60 is adhered to the insulating coating 24, the adhesion eliminates a gap between the water-stop member 60 and the insulating coating 24, and water-stop performance and the durability can be further increased. Specifically, the water-stop member 60 fills a gap with the insulating coating 24 by the adhesion on the inner side in the radial direction, and fills a gap with the housing 31 by the flat pressing on the outer side in the radial direction. Thus, water-stop performance and durability of the water-stop member 60 can be increased on the inner and outer sides in the radial direction.
Although the resin portion 41 of the above embodiment is adhered to the insulating coating 24, this need not be the case, and the resin portion 41 need not be adhered.
Although the insulating coating 24 and the resin portion 41 of the above embodiment are both made of polyolefin resin, the materials of the insulating coating 24 and the resin portion 41 may be changed. If the materials of the insulating coating 24 and the resin portion 41 are changed, it is preferable to employ materials with good adhesion with the insulating coating 24 and the resin portion 41.
Although the shielded wire 20 of the above embodiment has one electric wire 21, this need not be the case, and the shield wire 20 may be changed to a shielded wire having two or more electric wires 21 covered by one braided member 22 when the present disclosure is implemented.
Although the housing 31 of the above embodiment is of the connector 30, this need not be the case, and a housing of any other member may alternatively be employed.

The present disclosure includes the following modes. Some constituent elements of illustrative embodiments are assigned reference numerals as an aid to understanding, not for limitation. Some items described in the following modes may be omitted, and some items described in the modes may be selected or extracted and combined.

### Supplementary Note 1

In some implementation examples, a shielded wire (20) may have a core wire (23), a tubular insulating coating (24) covering an outer periphery of the core wire (23), and a tubular braided member (22) covering an outer periphery of the insulating coating (24).

### Supplementary Note 2

In some implementation examples, the housing (31) may cover a portion of the braided member (22) in a longitudinal direction.

### Supplementary Note 3

In some implementation examples, the water-stop member (40) may be shorter than the housing (31) in a longitudinal direction of the shielded wire (20).

### Supplementary Note 4

In some implementation examples, the wire harness (10) may include two water-stop members (40), and the two water-stop members (40) are located on respective ends of the housing (31) in a longitudinal direction of the shielded wire (20).

### Supplementary Note 5

In some implementation examples, the wire harness (10) may include at least one water-stop member (40), and each of the water-stop member (40) may include the elastic portion (42).

### Supplementary Note 6

In some implementation examples, an inner peripheral face of the water-stop member (40) or an inner peripheral face of the resin portion (41) may be in contact or intimate contact with an outer peripheral face of the insulating coating (24).

### Supplementary Note 7

In some implementation examples, an outer peripheral face of the water-stop member (40) or an outer peripheral face of the elastic portion (42) may be in contact or intimate contact with an inner peripheral face of the housing (31).

### Supplementary Note 8

In some implementation examples, the elastic portion (42) may be shorter than the resin portion (41) in a longitudinal direction of the shielded wire (20).

### Supplementary Note 9

In some implementation examples, the water-stop member (40) or the resin portion (41) may be integrated with the braided member (22).

### Supplementary Note 10

An inner peripheral face of the water-stop member (40) or an inner peripheral face of the resin portion (41) may be flush with an inner peripheral face of the braided member (22).

1. A wire harness comprising:
a shielded wire having a core wire, an insulating coating covering an outer periphery of the core wire, and a braid covering an outer periphery of the insulating coating;
a housing covering an outer periphery of the braid; and
a water-stop cover that fills a mesh of the braid and is located between the housing and the insulating coating,
wherein the water-stop cover has an elastic tube and is held between the housing and the insulating coating.

2. The wire harness according to claim 1, wherein:
the water-stop cover has a resin filler and the elastic tube,
the resin filler fills the mesh of the braid and is located in an area reaching the insulating coating, and
the elastic tube is held between the housing and the resin filler.

3. The wire harness according to claim 2,
wherein the elastic tube has a hardness lower than a hardness of the resin filler.

4. The wire harness according to claim 2,
wherein the resin filler is adhered to the insulating coating.

5. The wire harness according to claim 2,
wherein the insulating coating and the resin filler are both made of polyolefin resin.

6. The wire harness according to claim 1,
wherein the entire water-stop cover is the elastic tube.

7. The wire harness according to claim 6,
wherein an inner side of the water-stop cover in a radial direction is adhered to the insulating coating, and an outer side of the water-stop cover in the radial direction is flatly pressed and in intimate contact with the housing.
